(19) United States
(12) Patent Application Publication
(10) Pub. No.: US 2025/0182487 A1
(43) Pub. Date: Jun. 5, 2025

(54) METHODS AND SYSTEMS OF FACILITATING DETECTING AND MITIGATING THREATS POSED BY OBJECTS IN A REGION

(71) Applicants: Said El Bilani, Miami, FL (US); Brannon Castleberry, Houston, TX (US)

(72) Inventors: Said El Bilani, Miami, FL (US); Brannon Castleberry, Houston, TX (US)

(73) Assignee: 21ST CENTURY AEYE LLC, Austin, TX (US)

(21) Appl. No.: 18/965,879

(22) Filed: Dec. 2, 2024

Related U.S. Application Data
(60) Provisional application No. 63/604,686, filed on Nov. 30, 2023.

(51) Int. Cl. G06V 20/52; G06V 20/40

(52) U.S. Cl. CPC G06V 20/52; G06V 20/41

(57) ABSTRACT

The present disclosure provides a method of facilitating detecting and mitigating threats posed by objects in a region. Further, the method may include receiving one or more monitoring data from one or more monitoring devices. Further, the method may include analyzing the one or more monitoring data. Further, the method may include identifying one or more patterns in the one or more monitoring data based on the analyzing of the one or more monitoring data. Further, the method may include analyzing the one or more patterns. Further, the method may include classifying the one or more objects based on the analyzing of the one or more patterns. Further, the method may include generating one or more notifications of one or more threats associated with the one or more objects. Further, the method may include transmitting the one or more notifications to one or more devices.

### FIELD OF DISCLOSURE

The present disclosure generally relates to the field of data processing. More specifically, the present disclosure relates to methods and systems of facilitating detecting and mitigating threats posed by objects in a region.

### BACKGROUND

Artificial Intelligence (AI) refers to the simulation of human intelligence in machines programmed to perform tasks that typically require human intelligence. These tasks commonly include learning, reasoning, problem-solving, perception, speech recognition, and in this case, threat detection and real-time identification of weapons.

Traditional security systems often face challenges in promptly identifying potential threats, particularly in crowded public spaces or high-traffic areas. The need for a proactive and intelligent system capable of real-time weapon detection has become increasingly critical to prevent and mitigate security risks.

Therefore, there is a need for improved methods and systems for facilitating detecting and mitigating threats posed by objects in a region that may overcome one or more of the above-mentioned problems and/or limitations.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method of facilitating, detecting, and mitigating threats posed by objects in a region. Further, the method may include receiving, using a communication device, one or more monitoring data from one or more monitoring devices. Further, the one or more monitoring devices may be configured for monitoring one or more areas of the region. Further, the method may include analyzing, using a processing device, the one or more monitoring data using one or more computer vision algorithms. Further, the method may include identifying, using the processing device, one or more patterns in the one or more monitoring data based on the analyzing of the one or more monitoring data. Further, the one or more patterns may be associated with one or more object characteristic types of one or more objects presents in the one or more areas. Further, the method may include analyzing, using the processing device, the one or more patterns using one or more machine learning models. Further, the one or more machine learning models may be trained on two or more object data associated with two or more objects. Further, the two or more object data includes two or more threat capabilities associated two or more object characteristics of the two or more objects. Further, the method may include classifying, using the processing device, the one or more objects as one of a threatening object and a non-threatening object based on the analyzing of the one or more patterns. Further, the method may include generating, using the processing device, one or more notifications of one or more threats associated with the one or more objects based on the classifying of the one or more objects as the threatening object. Further, the method may include transmitting, using the communication device, the one or more notifications to one or more devices associated with one or more entities. Further, the method may include storing, using a storage device, the one or more monitoring data, and the one or more notifications.

The present disclosure provides a system for facilitating detecting and mitigating threats posed by objects in a region. Further, the system may include a communication device. Further, the communication device may be configured for receiving one or more monitoring data from one or more monitoring devices. Further, the one or more monitoring devices may be configured for monitoring one or more areas of the region. Further, the communication device may be configured for transmitting one or more notifications to one or more devices associated with one or more entities. Further, the system may include a processing device communicatively coupled with the communication device. Further, the processing device may be configured for analyzing the one or more monitoring data using one or more computer vision algorithms. Further, the processing device may be configured for identifying one or more patterns in the one or more monitoring data based on the analyzing of the one or more monitoring data. Further, the one or more patterns may be associated with one or more object characteristic types of one or more objects presents in the one or more areas. Further, the processing device may be configured for analyzing the one or more patterns using one or more machine learning models. Further, the one or more machine learning models may be trained on two or more object data associated with two or more objects. Further, the two or more object data includes two or more threat capabilities associated two or more object characteristics of the two or more objects. Further, the processing device may be configured for classifying the one or more objects as one of a threatening object and a non-threatening object based on the analyzing of the one or more patterns. Further, the processing device may be configured for generating the one or more notifications of one or more threats associated with the one or more objects based on the classifying of the one or more objects as the threatening object. Further, the system may include a storage device communicatively coupled with each of the processing device and the communication device. Further, the storage device may be configured for storing the one or more monitoring data and the one or more notifications.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3A illustrates a flowchart of a method 300 of facilitating detecting and mitigating threats posed by objects in a region, in accordance with some embodiments.

FIG. 3B illustrates a continuation of the flowchart of the method 300 of facilitating detecting and mitigating threats posed by objects in a region, in accordance with some embodiments.

FIG. 4 illustrates a flowchart of a method 400 of facilitating detecting and mitigating threats posed by objects in a region including generating, using the processing device 1004, at least one object data of the at least one object, in accordance with some embodiments.

FIG. 5 illustrates a flowchart of a method 500 of facilitating detecting and mitigating threats posed by objects in a region including retraining, using the processing device 1004, the at least one machine learning model, in accordance with some embodiments.

FIG. 6 illustrates a flowchart of a method 600 of facilitating detecting and mitigating threats posed by objects in a region including generating, using the processing device 1004, at least one threat data associated with the at least one threat, in accordance with some embodiments.

FIG. 7 illustrates a flowchart of a method 700 of facilitating detecting and mitigating threats posed by objects in a region including determining, using the processing device 1004, a threat level from a plurality of threat levels for the at least one object, in accordance with some embodiments.

FIG. 8 illustrates a flowchart of a method 800 of facilitating detecting and mitigating threats posed by objects in a region including determining, using the processing device 1004, a sensitiveness associated with each of the plurality of areas, in accordance with some embodiments.

FIG. 9 illustrates a flowchart of a method 900 of facilitating detecting and mitigating threats posed by objects in a region including identifying, using the processing device 1004, the at least one device from the plurality of devices, in accordance with some embodiments.

FIG. 10 illustrates a block diagram of a system 1000 of facilitating detecting and mitigating threats posed by objects in a region, in accordance with some embodiments.

FIG. 11 illustrates a block diagram of the system 1000, in accordance with some embodiments.

FIG. 12 illustrates a block diagram of the system 1000, in accordance with some embodiments.

FIG. 13 illustrates deployment of a system 1300 in an environment for facilitating detecting, and mitigating threats posed by object in a region, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes methods and systems of facilitating detecting and mitigating threats posed by objects in a region.

The present disclosed system, herein referred to as, “Integrated Autonomous AI Weapons Threat Detection, Location, and Alert Software Platform”, is a method for an advanced security system that significantly enhances threat detection capabilities by leveraging cutting-edge technology. Specifically, the disclosed system addresses the critical need for real-time identification of weapons within a monitored environment, such as public spaces, transportation hubs, or sensitive facilities. By doing so, the disclosed system acts as a proactive measure to mitigate potential security threats, serving as an added layer of security that enables swift alerts transmitted via a companion supplementary mobile app that provides administrators with real-time notifications and a comprehensive view of detected threats to aid in the responses from authorities to uphold public safety.

Further, the disclosed system aims to enhance security by detecting weapons through CCTV footage in real-time and facilitates instant notification to authorities via a mobile application, enabling quick response to potential threats.

Further, the Integrated Autonomous AI Weapons Threat Detection, Location, and Alert Software Platform accomplishes objective by way of:
A) Computer Vision Algorithms: Sophisticated Analysis—a) the core functionality relies on sophisticated computer vision algorithms. These algorithms are designed to meticulously analyze high-resolution video feeds obtained from CCTV cameras in real-time; b) The algorithms are capable of dissecting each frame, identifying and isolating potential threats by recognizing specific patterns associated with weapon shapes, sizes, and movements.
B) Machine Learning/Deep Learning Models: Precision through Training-a) Integral to the system are machine learning or deep learning models that have undergone extensive training. These models have acquired the ability to discern weapons from other objects with a high degree of accuracy; b) Continuous learning and adaptation are key features, ensuring the system's capacity to evolve and improve its recognition capabilities over time.
C) Alert Mechanism: a) Swift and Selective Alerts-Upon detection of a weapon, the system triggers a robust alert mechanism. This mechanism is finely tuned to minimize false positives and ensures that only validated threats prompt further action; b) Seamless Integration-Alerts seamlessly integrate with a mobile app notification system, allowing for swift transmission to designated bystanders and authorities. This integration ensures a rapid and coordinated response to potential security threats through a seamless integration with a companion notification system.

Further, the Integrated Autonomous AI Weapons Threat Detection, Location, and Alert Software Platform may include: a) Computer Vision Algorithms, these algorithms form the backbone of the system, providing the machine-learning mechanisms required for real-time analysis and threat detection; b) Machine Learning/Deep Learning Models, trained models contribute to the system's accuracy, allowing it to continuously learn and adapt to emerging threats. This iterative process ensures the system's resilience and adaptability over time; c) Notification System (End-to-End Management), the notification system is a pivotal component that manages the end-to-end process of alert generation and dissemination. It ensures that alerts are promptly communicated to the relevant authorities, minimizing response times and optimizing the overall efficacy of the security system; d) Mobile Application (User Interface and Action Hub), the mobile application serves as the user interface, enabling administrators to receive real-time notifications. Administrators can take immediate actions, such as escalating the threat level or coordinating a response, directly through the application interface; e) Computer Vision Algorithms, these are the core components responsible for analyzing CCTV footage and detecting weapons based on predefined patterns; f) Machine Learning/Deep Learning Models, trained models that recognize and differentiate weapons from other objects in the video feed; and g) Notification System, this component manages the process of sending alerts to the mobile application.—Mobile Application: The interface through which administrators receive notifications and can take further action (escalation based on level of threat).

Further, the working principle of the disclosed system may include a software utilizing a computer vision algorithms to analyze video feeds from CCTV cameras. The computer vision algorithm is trained to recognize weapon shapes, sizes, and movements using machine learning or deep learning models. When a weapon is detected, the software triggers an alert mechanism that sends notifications to the designated mobile application.

Further, steps to be performed by the disclosed system may include: a) Capturing CCTV Footage—The process begins with the acquisition of high-quality video feeds from strategically positioned CCTV cameras; b) Computer Vision Analysis—The captured footage undergoes real-time analysis through the application of advanced computer vision algorithms; c) Weapon Detection—The system employs machine learning or deep learning models to identify weapons based on predefined patterns and characteristics; d) Alert Triggering—An alert mechanism is activated upon successful weapon detection, initiating the rapid transmission of notifications; and e) Mobile Application Response-Administrators receive alerts on the mobile application, providing them with actionable intelligence to make informed decisions.

Further, the disclosed system may perform the following steps: a) Capturing CCTV footage; b) Applied computer vision algorithms for real-time analysis; c) Detected weapons based on predefined patterns/models; and e) Triggered notification to the mobile application upon detection.

Further, the system architecture of the disclosed system and the component interaction may include: a) Data Acquisition: The system initiates with the capture of high-resolution CCTV footage from strategically positioned cameras in the monitored environment. This foundational data forms the basis for subsequent analysis; b) Data Pre-processing: Raw video feeds undergo pre-processing to enhance clarity and eliminate noise. This ensures that the input data for analysis is of high quality, optimizing the accuracy of threat detection; c) Computer Vision Algorithms: Pre-processed data is fed into sophisticated computer vision algorithms, which meticulously analyze video frames in real-time. These algorithms are designed to identify and isolate potential threats by recognizing specific patterns associated with weapon shapes, sizes, and movements; d) Machine Learning/Deep Learning Models: Simultaneously, the output from the computer vision algorithms is channeled into machine learning or deep learning models. These models, having undergone extensive training, play a pivotal role in distinguishing weapons from non-threatening objects with a high degree of accuracy. Continuous learning and adaptation features ensure the system evolves and improves its recognition capabilities over time; e) Weapon Detection: The synergy between computer vision algorithms and machine learning models allows the system to detect weapons in real-time. This collaborative approach significantly reduces false positives and enhances the overall precision of the threat detection process; f) Alert Mechanism: Upon successful weapon detection, the alert mechanism is triggered. This mechanism is finely tuned to minimize false positives, ensuring that only validated threats prompt further action. Alerts are generated swiftly and seamlessly integrated with the notification system; g) Notification System: The alert seamlessly transmits to the notification system, acting as a central hub for communication. This component manages the end-to-end process of alert generation and dissemination, ensuring that alerts are promptly communicated to relevant authorities; h) Mobile Application Interface: The mobile application serves as the user interface, providing administrators with real-time notifications. Administrators can access detailed information about the detected threat, including the type of weapon and location. Immediate actions, such as escalating threat levels or coordinating responses, can be taken directly through the intuitive application interface; i) Administrative Actions: Administrators, empowered by the mobile application interface, can take immediate actions based on received alerts. This may include coordinating with law enforcement, initiating emergency protocols, or escalating threat levels based on the severity of the situation; and j) Continuous Learning Loop: The system incorporates a continuous learning loop, feeding data from new detections and administrative responses back into the machine learning models. This iterative process enhances the system's ability to adapt to emerging threats, ensuring continuous improvement over time.

The orchestrated interaction of the components within the system architecture creates a seamless and responsive security framework. The combination of advanced computer vision, machine learning, and real-time alerting mechanisms ensures a comprehensive solution for the identification and mitigation of potential security threats. The continuous learning loop further enhances the disclosed system's adaptability, making it well-equipped to evolve in the face of changing threat landscapes. By optimizing the workflow and interconnectivity of these components, the disclosed system contributes to a highly efficient and effective security system that addresses the critical need for real-time weapon detection and threat mitigation.

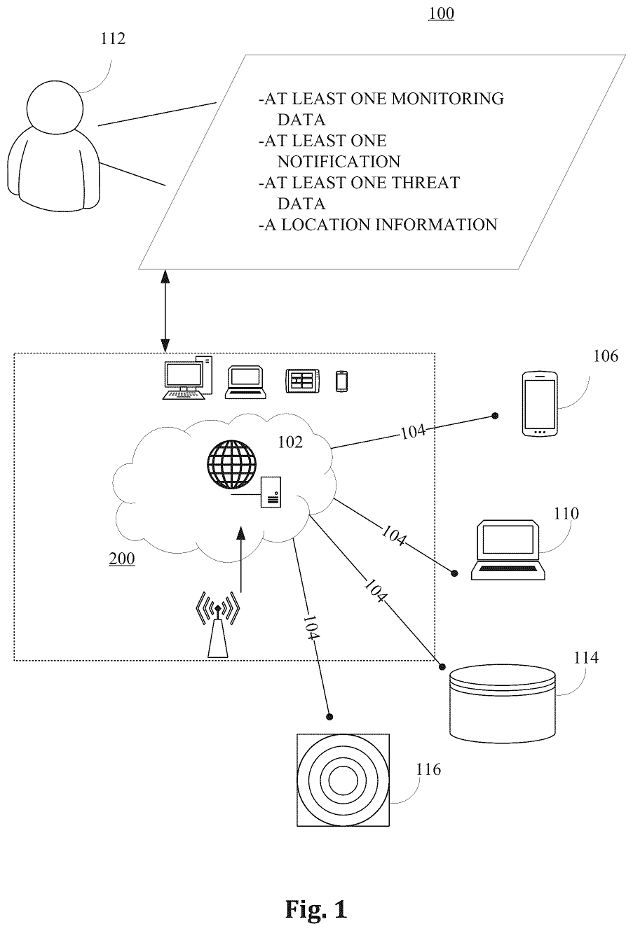

FIG. 1 is an illustration of an online platform 100 consistent with various embodiments of the present disclosure. By way of non-limiting example, the online platform 100 to facilitate detecting and mitigating threats posed by objects in a region, may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

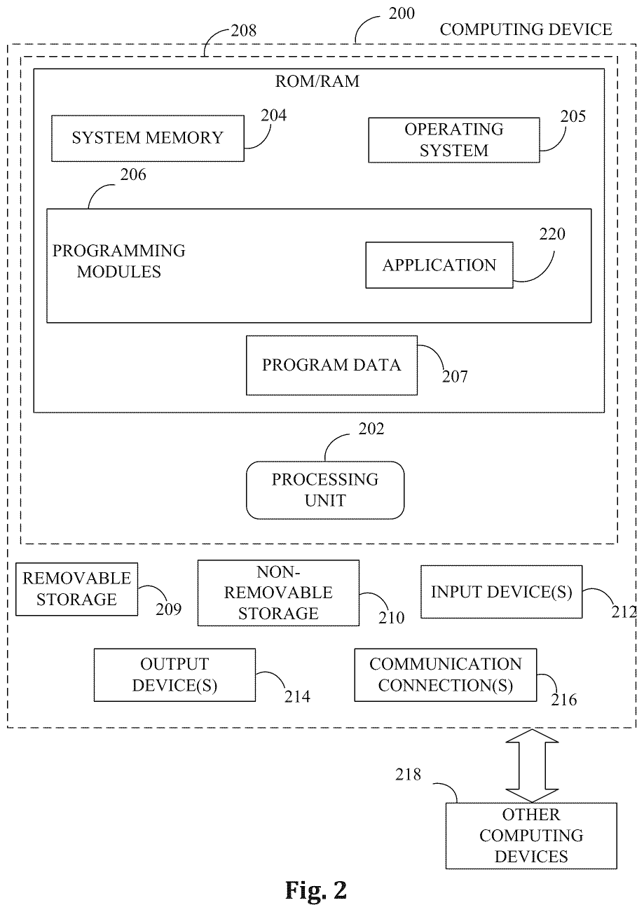

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module and, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable, and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include but is not limited to, RAM, ROM, electrically erasable read-only memory (EEPROM), flash memory or other memory technology, CD-ROM, digital versatile disks (DVD), or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

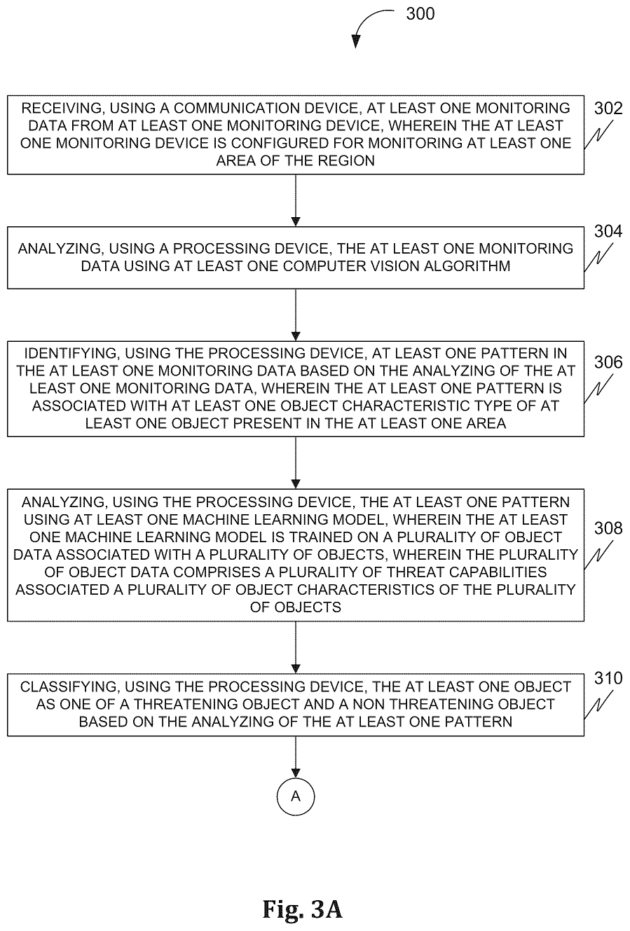

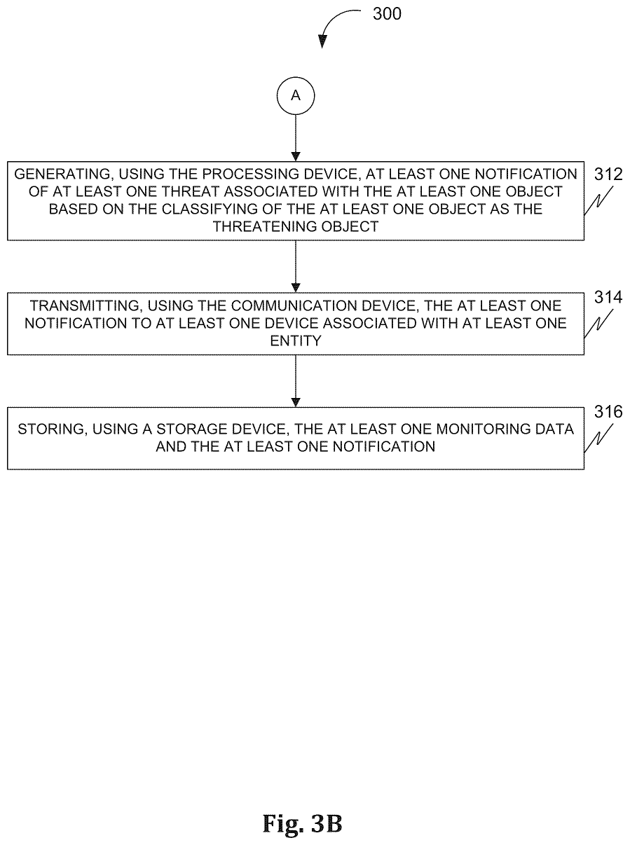

FIG. 3A and FIG. 3B illustrate a flowchart of a method 300 of facilitating detecting and mitigating threats posed by objects in a region, in accordance with some embodiments.

Accordingly, the method 300 may include a step 302 of receiving, using a communication device 1002, one or more monitoring data from one or more monitoring devices (such as the monitoring device 1102). Further, the one or more monitoring devices may be configured for monitoring one or more areas of the region.

In some embodiments, the one or more monitoring data includes one or more visual data associated with one or more of a visible light region of electromagnetic spectrum, an infrared region of the electromagnetic spectrum, an ultraviolet region of the electromagnetic spectrum, and an X ray region of the electromagnetic spectrum, one or more audio data associated with an infrasonic region of the sound, a sonic region of the sound, and an ultrasonic region of the sound, one or more location data, one or more time data.

In some embodiments, the one or more monitoring devices may be physically present in the region. Further, the one or more monitoring devices traverses the region and/or the one or more areas of the region. Further, the one or more monitoring device may be comprised in one or more vehicles. Further, the one or more vehicles may be a land vehicle, and an aerial vehicle.

In some embodiments, the one or more monitoring data includes a data stream. In some embodiments, the one or more monitoring data includes a Close Circuit Television (CCTV) data generated by a Close Circuit Television (CCTV) camera of the one or more monitoring devices.

In some embodiments, the one or more monitoring data includes a multi spectral imaging data. Further, the processing device 1004 may be configured to determine a composition data of the one or more objects based on the multi spectral imaging data. Further, the composition data may indicate a metallicity of the one or more objects. Further, the metallicity indicate the one or more objects may be metallic, non-metallic, alloy, type of metal, etc.

In some embodiments, the one or more regions includes one or more of a floor, a street, a building, and a surveillance space and/or area, and a monitored area.

Further, the method 300 may include a step 304 of analyzing, using a processing device 1004, the one or more monitoring data using one or more computer vision algorithms.

Further, the computer vision algorithms may include edge detection algorithm, thresholding algorithm, image filtering algorithm, corner detection algorithm, image segmentation algorithm, object detection algorithm, image classification algorithm, object tracking algorithm, etc.

Further, the method 300 may include a step 306 of identifying, using the processing device 1004, one or more patterns in the one or more monitoring data based on the analyzing of the one or more monitoring data.

In some embodiments, the one or more patterns may be a predefined pattern, a specific pattern, etc.

Further, the one or more patterns may be associated with one or more object characteristic types of one or more objects presents in the one or more areas.

In some embodiments, the one or more object characteristic types includes one or more of an object shape, an object size, and an object movement.

Further, the method 300 may include a step 308 of analyzing, using the processing device 1004, the one or more patterns using one or more machine learning models.

In some embodiments, the one or more machine learning models includes one or more of a supervised learning model, a semi-supervised learning model, an unsupervised learning model, and a reinforcement learning model.

In some embodiments, the one or more machine learning models includes one or more of a regression model, a support vector machine model, a decision tree model, etc.

In some embodiments, the one or more machine learning models includes a neural network. In some embodiments, the neural network includes one or more an artificial neural network, a convolutional neural network, a deep neural network, recurrent neural network, and a feed-forward neural network.

Further, the one or more machine learning models may be trained on two or more object data associated with two or more objects. Further, the two or more object data includes two or more threat capabilities associated two or more object characteristics of the two or more objects. Further, the method 300 may include a step 310 of classifying, using the processing device 1004, the one or more objects as one of a threatening object and a non-threatening object based on the analyzing of the one or more patterns.

In some embodiments, the threatening object includes one or more of one or more firearms, one or more melee weapons, and an explosive weapon. Further, the threatening object poses threat to the one or more entities. Further, the non-threatening objects includes a wearable, an apparel, a tool, a device, an item, etc. Further, the non-threatening objects do not poses a threat to the one or more entities.

Further, the method 300 may include a step 312 of generating, using the processing device 1004, one or more notifications of one or more threats associated with the one or more objects based on the classifying of the one or more objects as the threatening object. Further, the method 300 may include a step 314 of transmitting, using the communication device 1002, the one or more notifications to one or more devices associated with one or more entities.

In some embodiments, the one or more devices includes a client device, a computer device, a user device, an output device, a smart device, a smartphone, a mobile, a computer, and a telecommunication device.

In some embodiments, the one or more entities includes one or more of a law enforcement entity, a relevant authority, an individual, a user, a bystander, and a group of people. In some embodiments, the one or more entities includes an administrative entity.

In some embodiments, the generating and the transmitting of the one or more notifications may be performed in real time.

Further, the method 300 may include a step 316 of storing, using a storage device 1006, the one or more monitoring data and the one or more notifications.

In some embodiments, the storage device 1006 includes one or more of a volatile memory and a non-volatile memory.

In some embodiments, the one or more monitoring devices includes one or more sensors. Further, the one or more sensors may be configured for generating the one or more monitoring data based on detecting one or more monitoring parameters associated with the one or more areas.

Further, the one or more monitoring parameters include a visual, an acoustic, a temperature, a motion, a location, a geolocation, etc. Further, the one or more sensor may include one or more image sensors (such as visual light image sensor, infrared image sensor, ultraviolet image sensor, X-ray image sensor, multi spectral image sensor, hyper spectral image sensor, etc.), one or more sound sensors (such as a sonic sensor, ultra sonic sensor, infra sonic sensor, etc.), a temperature sensor, a motion sensor, a location sensor, a geolocation sensor, etc.

In some embodiments, one or more of the analyzing of the one or more monitoring data, the identifying of the one or more patterns, the analyzing of the one or more patterns, the classifying of the one or more objects, and the generating of the one or more notifications may be redundantly performed in a distributed processing manner.

In some embodiments, the method 300 may further include streaming, using the processing device 1004, the one or more monitoring data to the one or more devices based on based on the classifying of the one or more objects as the threatening object. In some embodiments, the streaming of the one or more monitoring data may be in real time.

In some embodiments, the method may further include pre-processing, using the processing device, the one or more monitoring data. Further, the pre-processing facilitates an enhancement in quality of the one or more monitoring data.

In some embodiments, the transmitting of the one or more notifications may be further based on one or more of the one or more objects, the one or more object characteristics associated with the one or more objects, and a proximity of the one or more devices with the one or more object presents in the region.

In some embodiments, the one or more monitoring data includes a data stream. Further, the analyzing of the one or more monitoring data includes analyzing one or more frames of the data stream. Further, the one or more monitoring data may include one or more images, one or more videos, etc.

In some embodiments, the method may further include communicating, using the communication device 1002, with a third party platform using an API. Further, the communication facilitates transmitting of the one or more notifications.

Further, in some embodiments, the method further may include generating, using the processing device 1004, one or more user interfaces which may be configured to present the one or more notifications to the one or more entities. Further, in some embodiments, the method further may include transmitting, using the communication device 1002, the one or more user interfaces to the one or more devices.

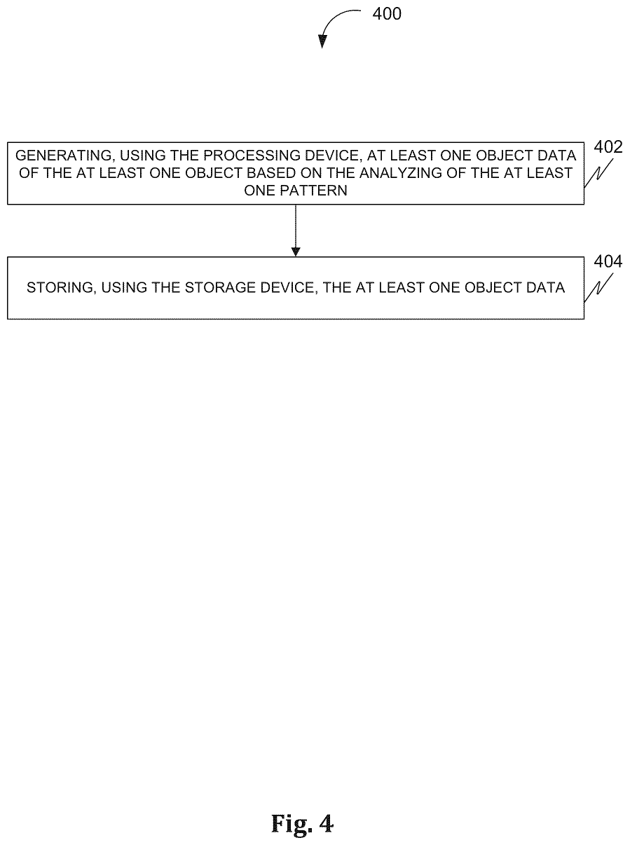

FIG. 4 illustrates a flowchart of a method 400 of facilitating detecting and mitigating threats posed by objects in a region including generating, using the processing device 1004, at least one object data of the at least one object, in accordance with some embodiments.

Further, in some embodiments, the method 400 further may include a step 402 of generating, using the processing device 1004, one or more object data of the one or more objects based on the analyzing of the one or more patterns. Further, in some embodiments, the method 400 further may include a step 404 of storing, using the storage device 1006, the one or more object data.

Further, the one or more object data may include a threat capability of the one or more objects, an object characteristic of the one or more objects, etc.

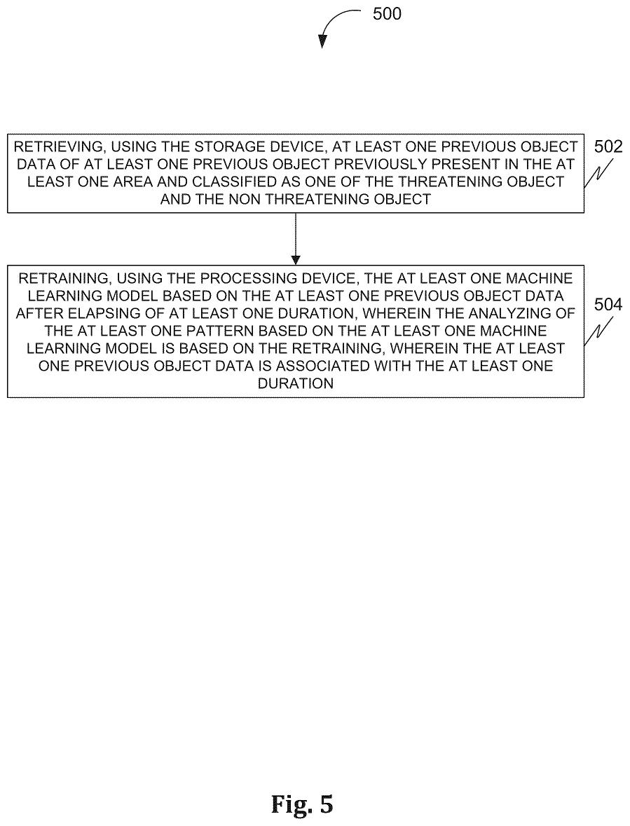

FIG. 5 illustrates a flowchart of a method 500 of facilitating detecting and mitigating threats posed by objects in a region including retraining, using the processing device 1004, the at least one machine learning model, in accordance with some embodiments.

Further, in some embodiments, the method 500 further may include a step 502 of retrieving, using the storage device 1006, one or more previous object data of one or more previous objects previously present in the one or more areas and classified as one of the threatening object and the non-threatening object. Further, in some embodiments, the method 500 further may include a step 504 of retraining, using the processing device 1004, the one or more machine learning models based on the one or more previous object data after elapsing of one or more durations. Further, the analyzing of the one or more patterns based on the one or more machine learning models may be based on the retraining. Further, the one or more previous object data may be associated with the one or more durations.

Further, the one or more previous object data may include a threat capability of the one or more previous objects, an object characteristic of the one or more previous objects, etc.

Further, the retraining of the one or more machine learning models happen in a periodic manner after the elapsing of the one or more duration. Further, at least one of a hyper parameter and a model parameter of the one or more machine learning models may be turned based on the retraining.

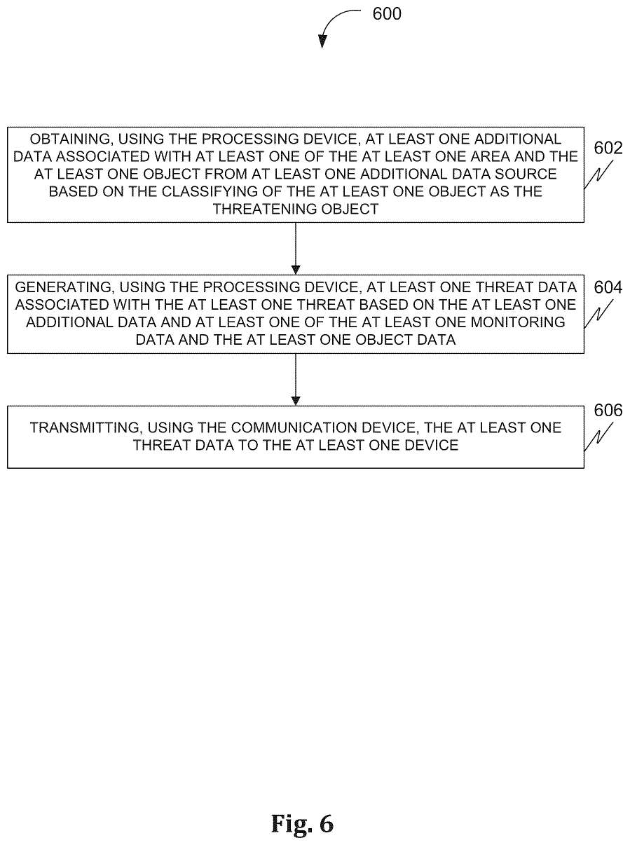

FIG. 6 illustrates a flowchart of a method 600 of facilitating detecting and mitigating threats posed by objects in a region including generating, using the processing device 1004, at least one threat data associated with the at least one threat, in accordance with some embodiments.

Further, in some embodiments, the method 600 further may include a step 602 of obtaining, using the processing device 1004, one or more additional data associated with one or more of the one or more areas and the one or more objects from one or more additional data sources based on the classifying of the one or more objects as the threatening object.

In some embodiments, the one or more additional data includes one or more of one or more geolocation data, one or more additional object data associated with the one or more objects, one or more maps of the region. In some embodiments, the one or more additional object data includes one or more of one or more design data, one or more type data, and one or more lethality data.

In some embodiments, the one or more additional data sources includes one or more of one or more databases, and one or more geolocation sensors.

Further, in some embodiments, the method 600 further may include a step 604 of generating, using the processing device 1004, one or more threat data associated with the one or more threats based on the one or more additional data and one or more of the one or more monitoring data and the one or more object data. Further, in some embodiments, the method 600 further may include a step 606 of transmitting, using the communication device 1002, the one or more threat data to the one or more devices.

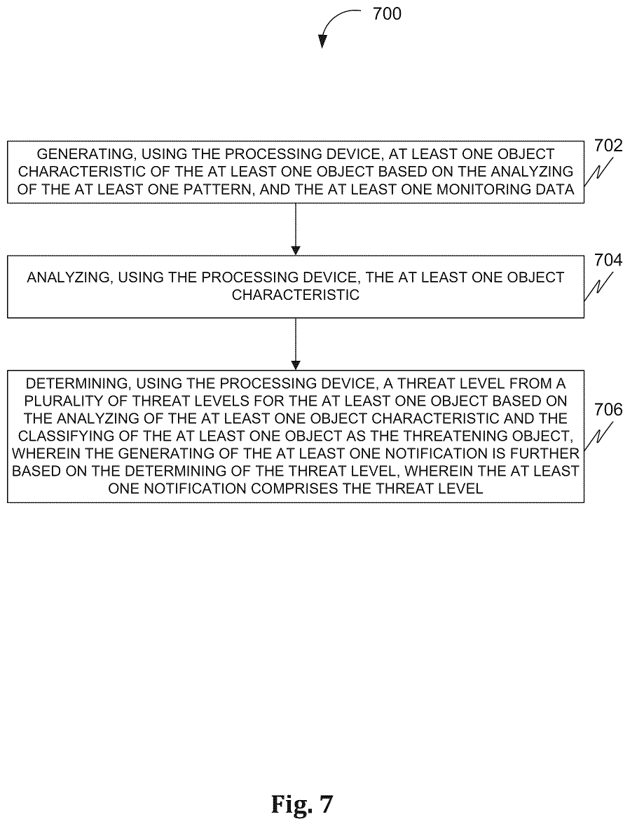

FIG. 7 illustrates a flowchart of a method 700 of facilitating detecting and mitigating threats posed by objects in a region including determining, using the processing device 1004, a threat level from a plurality of threat levels for the at least one object, in accordance with some embodiments.

Further, in some embodiments, the method 700 further may include a step 702 of generating, using the processing device 1004, one or more object characteristics of the one or more objects based on the analyzing of the one or more patterns, and the one or more monitoring data.

In some embodiments, the one or more object characteristics includes a specific shape, specific size, a specific type, a specific movement, a specific geolocation, and a specific location.

Further, in some embodiments, the method 700 further may include a step 704 of analyzing, using the processing device 1004, the one or more object characteristics. Further, in some embodiments, the method 700 further may include a step 706 of determining, using the processing device 1004, a threat level from two or more threat levels for the one or more objects based on the analyzing of the one or more characteristics and the classifying of the one or more objects as the threatening object. Further, the generating of the one or more notifications may be further based on the determining of the threat level. Further, the one or more notifications includes the threat level.

Further, the two or more threat levels may include a range of threat level from a minimum threat level to a maximum threat level.

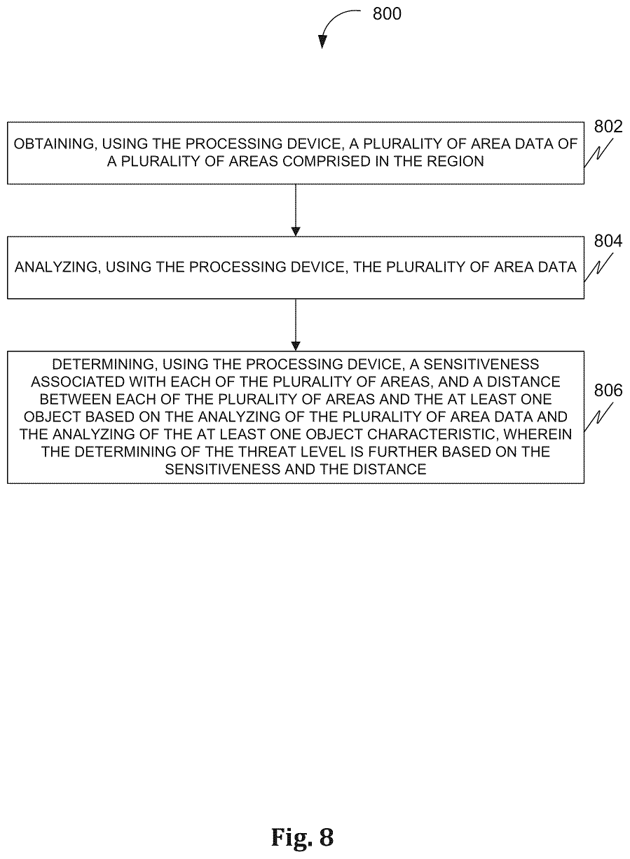

FIG. 8 illustrates a flowchart of a method 800 of facilitating detecting and mitigating threats posed by objects in a region including determining, using the processing device 1004, a sensitiveness associated with each of the plurality of areas, in accordance with some embodiments.

Further, in some embodiments, the method 800 further may include a step 802 of obtaining, using the processing device 1004, two or more area data of two or more areas comprised in the region.

In some embodiments, the two or more area data may be received from two or more monitoring devices comprised within the region. Further, the two or more areas data may include an environmental condition, a political condition, a social condition, an economic condition, a location, a geolocation, etc. of the two or more areas.

Further, in some embodiments, the method 800 further may include a step 804 of analyzing, using the processing device 1004, the two or more area data. Further, in some embodiments, the method 800 further may include a step 806 of determining, using the processing device 1004, a sensitiveness associated with each of the two or more areas based on the analyzing of the two or more area data and the analyzing of the one or more object characteristics. Further, the determining of the threat level may be further based on the sensitiveness.

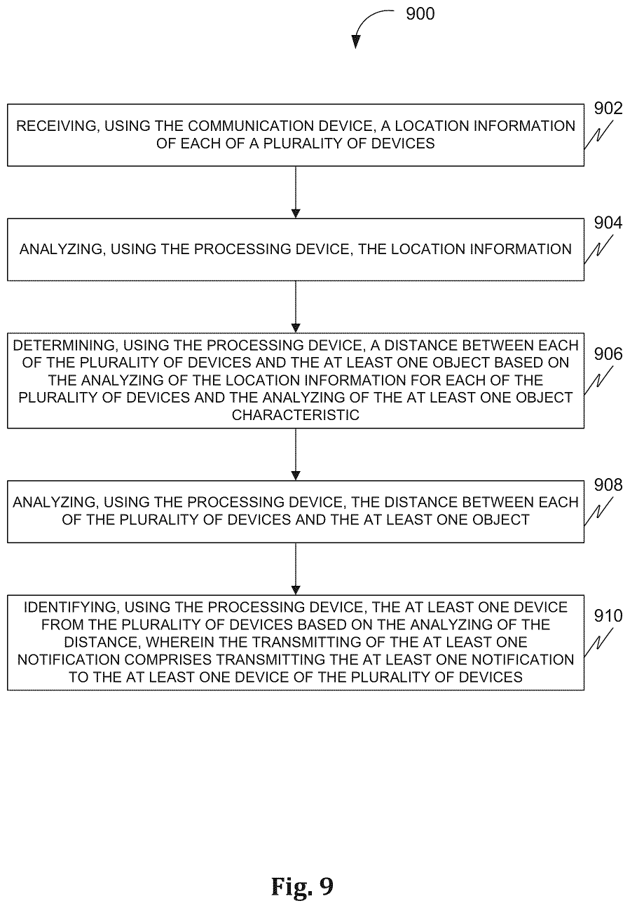

FIG. 9 illustrates a flowchart of a method 900 of facilitating detecting and mitigating threats posed by objects in a region including identifying, using the processing device 1004, the at least one device from the plurality of devices, in accordance with some embodiments.

Further, in some embodiments, the method 900 further may include a step 902 of receiving, using the communication device 1002, a location information of each of two or more devices. Further, in some embodiments, the method 900 further may include a step 904 of analyzing, using the processing device 1004, the location information. Further, in some embodiments, the method 900 further may include a step 908 of analyzing, using the processing device 1004, a relationship between each of the two or more devices and the one or more objects. Further, in some embodiments, the method 900 further may include a step 910 of identifying, using the processing device 1004, the one or more devices from the two or more devices. Further, the transmitting of the one or more notifications includes transmitting the one or more notifications to the one or more devices of the two or more devices.

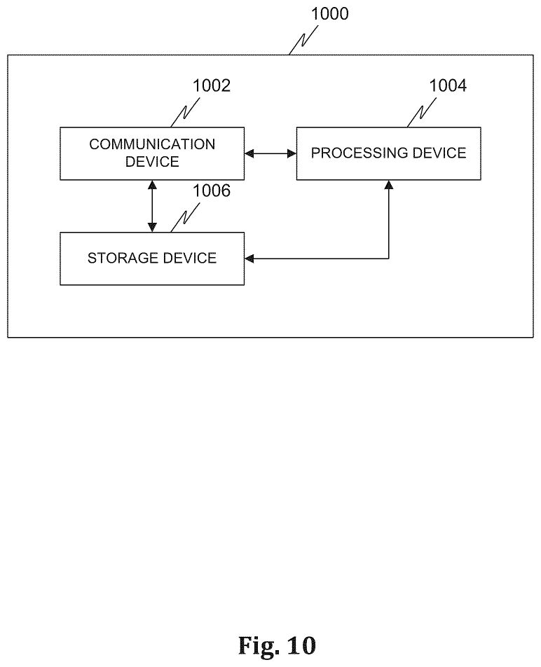

FIG. 10 illustrates a block diagram of a system 1000 of facilitating detecting and mitigating threats posed by objects in a region, in accordance with some embodiments.

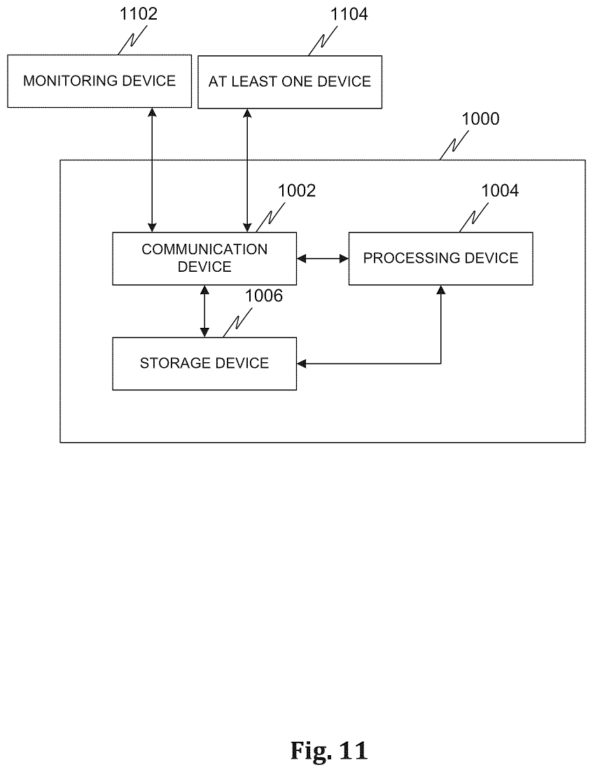

Accordingly, the system 1000 may include a communication device 1002. Further, the communication device 1002 may be configured for receiving one or more monitoring data from one or more monitoring devices 1102 (as shown in FIG. 11). Further, the one or more monitoring devices may be configured for monitoring one or more areas of the region. Further, the communication device 1002 may be configured for transmitting one or more notifications to one or more devices 1104 (as shown in FIG. 11) associated with one or more entities. Further, the system 1000 may include a processing device 1004 communicatively coupled with the communication device 1002. Further, the processing device 1004 may be configured for analyzing the one or more monitoring data using one or more computer vision algorithms. Further, the processing device 1004 may be configured for identifying one or more patterns in the one or more monitoring data based on the analyzing of the one or more monitoring data. Further, the one or more patterns may be associated with one or more object characteristic types of one or more objects presents in the one or more areas. Further, the processing device 1004 may be configured for analyzing the one or more patterns using one or more machine learning models. Further, the one or more machine learning models may be trained on two or more object data associated with two or more objects. Further, the two or more object data includes two or more threat capabilities associated two or more object characteristics of the two or more objects. Further, the processing device 1004 may be configured for classifying the one or more objects as one of a threatening object and a non-threatening object based on the analyzing of the one or more patterns. Further, the processing device 1004 may be configured for generating the one or more notifications of one or more threats associated with the one or more objects based on the classifying of the one or more objects as the threatening object. Further, the system 1000 may include a storage device 1006 communicatively coupled with each of the processing device 1004 and the communication device 1002. Further, the storage device 1006 may be configured for storing the one or more monitoring data and the one or more notifications.

In some embodiments, the processing device 1004 may be further configured for generating one or more object data of the one or more objects based on the analyzing of the one or more patterns. Further, the storage device 1006 may be further configured for storing the one or more object data.

In some embodiments, the storage device 1006 may be further configured for retrieving one or more previous object data of one or more previous objects previously present in the one or more areas and classified as one of the threatening object and the non-threatening object. Further, the processing device 1004 may be further configured for retraining the one or more machine learning models based on the one or more previous object data after elapsing of one or more durations. Further, the analyzing of the one or more patterns based on the one or more machine learning models may be based on the retraining. Further, the one or more previous object data may be associated with the one or more durations.

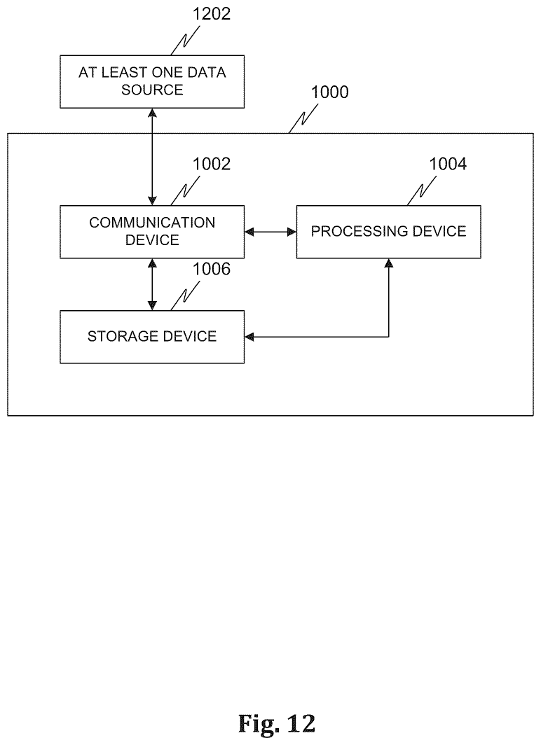

Further, in some embodiments, the processing device 1004 may be further configured for obtaining one or more additional data associated with one or more of the one or more areas and the one or more objects from one or more additional data sources 1202 (as shown in FIG. 12) based on the classifying of the one or more objects as the threatening object. Further, the processing device 1004 may be further configured for generating one or more threat data associated with the one or more threats based on the one or more additional data and one or more of the one or more monitoring data, and the one or more object data. Further, the communication device 1002 may be further configured for transmitting the one or more threat data to the one or more devices.

In some embodiments, the one or more monitoring devices includes one or more sensors. Further, the one or more sensors may be configured for generating the one or more monitoring data based on detecting one or more monitoring parameters associated with the one or more areas.

In some embodiments, one or more of the analyzing of the one or more monitoring data, the identifying of the one or more patterns, the analyzing of the one or more patterns, the classifying of the one or more objects, and the generating of the one or more notifications may be redundantly performed in a distributed processing manner.

Further, in some embodiments, the processing device 1004 may be further configured for generating one or more object characteristics of the one or more objects based on the analyzing of the one or more patterns, and the one or more monitoring data. Further, the processing device 1004 may be further configured for analyzing the one or more object characteristics. Further, the processing device 1004 may be further configured for determining a threat level from two or more threat levels for the one or more objects based on the analyzing of the one or more object characteristics and the classifying of the one or more objects as the threatening object. Further, the generating of the one or more notifications may be further based on the determining of the threat level. Further, the one or more notifications includes the threat level.

Further, in some embodiments, the communication device 1002 may be further configured for receiving a location information of each of two or more devices. Further, the processing device 1004 may be further configured for analyzing the location information. Further, the processing device 1004 may be further configured for determining a relationship between each of the two or more devices and the one or more objects based on the analyzing of the location information for each of the two or more devices and the analyzing of the one or more object characteristics. Further, the transmitting of the one or more notifications includes transmitting the one or more notifications to the one or more devices of the two or more devices.

In some embodiments, the processing device 1004 may be further configured for streaming the one or more monitoring data to the one or more devices based on based on the classifying of the one or more objects as the threatening object.

FIG. 11 illustrates a block diagram of the system 1000, in accordance with some embodiments.

FIG. 12 illustrates a block diagram of the system 1000, in accordance with some embodiments.

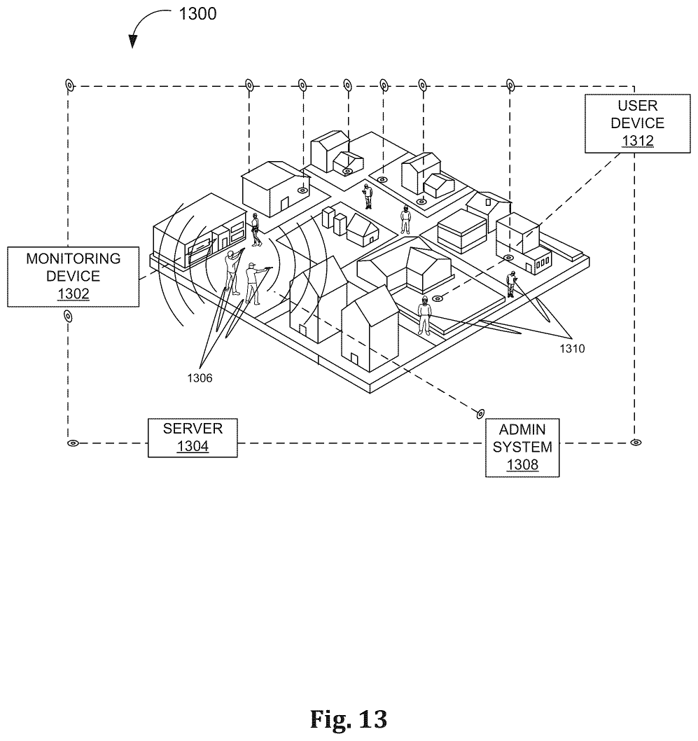

FIG. 13 illustrates deployment of a system 1300 in an environment for facilitating detecting, and mitigating threats posed by object in a region, in accordance with some embodiments.

Accordingly, the system 1300 may include a monitoring device 1302 which may be configured to generate one or more monitoring data one or more areas of the region. Further, the system 1300 may include a server 1304. Further, the server 1304 may be configured for obtaining the one or more monitoring data from the monitoring device 1302. Further, the server 1304 may be configured for analyzing the one or more monitoring data using one or more machine learning models. Further, the server 1304 may be configured for determining a threatening object 1306 present in the one or more areas of the region. Further, the server 1304 may be configured for generating one or more notifications based on the determining of the one or more threatening objects 1306. Further, the server may be configured for transmitting the one or more notifications to one or more admin devices 1308 associated with an admin, and a user device 1312 associated with an entity 1310.

In some embodiments, the server 1304 may be further configured to stream the one or more monitoring data to the one or more admin devices 1308.

In some embodiments, the admin device 1308 may be further configured to transmit the one or more notifications to one or more relevant authorities based on an admin input received from the admin.

Although the invention has been explained in relation to its preferred embodiment, it is to be understood that many other possible modifications and variations can be made without departing from the spirit and scope of the invention as hereinafter claimed.

### Aspects

A system for identifying and reporting weapons using streaming image data from visible and/or non-visible light (not visible to the human eye), comprising:
a plurality of data sources, including cameras, hyperspectral cameras, or other remote sensing methods configured to capture video, spectral data, or other pertinent data of an area under surveillance;
a processing unit operatively connected to the data sources; the processing unit configured to:
   receive video streams and spectral data from the cameras or other remote sensing devices;
   analyze the video streams using an Artificial Intelligence image recognition algorithm, wherein AI algorithms are trained using Machine Learning systems to identify several types of weapons, including guns and knives;
   determine the location of a detected weapon using spatial data associated with the cameras and/or geolocation data from primary or secondary sources;
a notification module configured to:
   generate an alert when a weapon is detected;
   compile information about the weapon threat, including its type, location, and description; and
   transmit the alert and associated information to a remote device or central monitoring system for display to authorized personnel.

The system of aspect 1, wherein the security cameras are configured to operate in non-visible spectral bands to enhance weapon detection under adverse-light conditions.

The system of aspect 1, wherein the notification module transmits information in real-time to a mobile device, tablet, or workstation of authorized personnel.

The method of aspect 1, wherein the notification includes a visual representation of the detected weapon, a map of its location within the monitored area, and a timestamp of the detection.

The system of aspect 1, further comprises a user interface on the remote device configured to display the weapon threat details, live video feed from the detecting camera, and options for initiating further security actions.

The system of aspect 1, wherein the processing unit employs AI algorithms optimized for real-time weapon detection.

The system of aspect 1, wherein the notification system includes an application programming interface (API) for integration with third-party security platforms.

The system of aspect 1, is a method of redundancy to ensure uninterrupted detection due to a failure by redistributing processing loads.

The method of aspect 1, wherein the deep learning algorithm is periodically retrained using newly collected weapon data to improve detection accuracy.

The method of aspect 1, further comprises a step of analyzing object movement patterns to distinguish between weapons and benign objects such as tools.

The method of aspect 1, wherein the multispectral imaging data is used to identify specific metallic or non-metallic compositions of weapons.

The system of aspect 1, wherein the thermal spectral range is used to detect concealed weapons based on temperature anomalies.

The system of aspect 1, wherein the notification system provides situational alerts categorized by threat level, including weapon type and proximity to sensitive areas.

What is claimed is:

1. A method of facilitating detecting and mitigating threats posed by objects in a region, the method comprising:
receiving, using a communication device, at least one monitoring data from at least one monitoring device, wherein the at least one monitoring device is configured for monitoring at least one area of the region;
analyzing, using a processing device, the at least one monitoring data using at least one computer vision algorithm;
identifying, using the processing device, at least one pattern in the at least one monitoring data based on the analyzing of the at least one monitoring data, wherein the at least one pattern is associated with at least one object characteristic type of at least one object present in the at least one area;
analyzing, using the processing device, the at least one pattern using at least one machine learning model, wherein the at least one machine learning model is trained on a plurality of object data associated with a plurality of objects, wherein the plurality of object data comprises a plurality of threat capabilities associated a plurality of object characteristics of the plurality of objects;
classifying, using the processing device, the at least one object as one of a threatening object and a non-threatening object based on the analyzing of the at least one pattern;
generating, using the processing device, at least one notification of at least one threat associated with the at least one object based on the classifying of the at least one object as the threatening object;
transmitting, using the communication device, the at least one notification to at least one device associated with at least one entity; and
storing, using a storage device, the at least one monitoring data and the at least one notification.

2. The method of claim 1 further comprising:
generating, using the processing device, at least one object data of the at least one object based on the analyzing of the at least one pattern; and
storing, using the storage device, the at least one object data.

3. The method of claim 2 further comprising:
retrieving, using the storage device, at least one previous object data of at least one previous object previously present in the at least one area and classified as one of the threatening object and the non-threatening object; and
retraining, using the processing device, the at least one machine learning model based on the at least one previous object data after elapsing of at least one duration, wherein the analyzing of the at least one pattern based on the at least one machine learning model is based on the retraining, wherein the at least one previous object data is associated with the at least one duration.

4. The method of claim 1 further comprising:
obtaining, using the processing device, at least one additional data associated with at least one of the at least one area and the at least one object from at least one additional data source based on the classifying of the at least one object as the threatening object;
generating, using the processing device, at least one threat data associated with the at least one threat based on the at least one additional data and at least one of the at least one monitoring data and the at least one object data; and
transmitting, using the communication device, the at least one threat data to the at least one device.

5. The method of claim 1, wherein the at least one monitoring device comprises at least one sensor, wherein the at least one sensor is configured for generating the at least one monitoring data based on detecting at least one monitoring parameter associated with the at least one area.

6. The method of claim 1, wherein at least one of the analyzing of the at least one monitoring data, the identifying of the at least one pattern, the analyzing of the at least one pattern, the classifying of the at least one object, and the generating of the at least one notification is redundantly performed in a distributed processing manner.

7. The method of claim 1 further comprising:
generating, using the processing device, at least one object characteristic of the at least one object based on the analyzing of the at least one pattern, and the at least one monitoring data;
analyzing, using the processing device, the at least one object characteristic; and
determining, using the processing device, a threat level from a plurality of threat levels for the at least one object based on the analyzing of the at least one object characteristic and the classifying of the at least one object as the threatening object, wherein the generating of the at least one notification is further based on the determining of the threat level, wherein the at least one notification comprises the threat level.

8. The method of claim 7 further comprising:
obtaining, using the processing device, a plurality of area data of a plurality of areas comprised in the region;
analyzing, using the processing device, the plurality of area data; and
determining, using the processing device, a sensitiveness associated with each of the plurality of areas based on the analyzing of the plurality of area data and the analyzing of the at least one object characteristic, wherein the determining of the threat level is further based on the sensitiveness.

9. The method of claim 1 further comprising streaming, using the processing device, the at least one monitoring data to the at least one device based on based on the classifying of the at least one object as the threatening object.

10. A system for facilitating detecting and mitigating threats posed by objects in a region, the system comprising:
a communication device configured for:
receiving at least one monitoring data from at least one monitoring device, wherein the at least one monitoring device is configured for monitoring at least one area of the region;
transmitting at least one notification to at least one device associated with at least one entity;
a processing device communicatively coupled with the communication device, wherein the processing device is configured for:
analyzing the at least one monitoring data using at least one computer vision algorithm;
identifying at least one pattern in the at least one monitoring data based on the analyzing of the at least one monitoring data, wherein the at least one pattern is associated with at least one object characteristic type of at least one object present in the at least one area;
analyzing the at least one pattern using at least one machine learning model, wherein the at least one machine learning model is trained on a plurality of object data associated with a plurality of objects, wherein the plurality of object data comprises a plurality of threat capabilities associated a plurality of object characteristics of the plurality of objects;
classifying the at least one object as one of a threatening object and a non-threatening object based on the analyzing of the at least one pattern;
generating the at least one notification of at least one threat associated with the at least one object based on the classifying of the at least one object as the threatening object; and
a storage device communicatively coupled with each of the processing device and the communication device, wherein the storage device is configured for:
storing the at least one monitoring data and the at least one notification.

11. The system of claim 10, wherein the processing device is further configured for generating at least one object data of the at least one object based on the analyzing of the at least one pattern, wherein the storage device is further configured for storing the at least one object data.

12. The system of claim 11, wherein the storage device is further configured for retrieving at least one previous object data of at least one previous object previously present in the at least one area and classified as one of the threatening object and the non-threatening object, wherein the processing device is further configured for retraining the at least one machine learning model based on the at least one previous object data after elapsing of at least one duration, wherein the analyzing of the at least one pattern based on the at least one machine learning model is based on the retraining, wherein the at least one previous object data is associated with the at least one duration.

13. The system of claim 10, wherein the processing device is further configured for:
obtaining at least one additional data associated with at least one of the at least one area and the at least one object from at least one additional data source based on the classifying of the at least one object as the threatening object;
generating at least one threat data associated with the at least one threat based on the at least one additional data and at least one of the at least one monitoring data and the at least one object data, wherein the communication device is further configured for transmitting the at least one threat data to the at least one device.

14. The system of claim 10, wherein the at least one monitoring device comprises at least one sensor, wherein the at least one sensor is configured for generating the at least one monitoring data based on detecting at least one monitoring parameter associated with the at least one area.

15. The system of claim 10, wherein at least one of the analyzing of the at least one monitoring data, the identifying of the at least one pattern, the analyzing of the at least one pattern, the classifying of the at least one object, and the generating of the at least one notification is redundantly performed in a distributed processing manner.

16. The system of claim 10, wherein the processing device is further configured for:
generating at least one object characteristic of the at least one object based on the analyzing of the at least one pattern, and the at least one monitoring data;
analyzing the at least one object characteristic; and
determining a threat level from a plurality of threat levels for the at least one object based on the analyzing of the at least one object characteristic and the classifying of the at least one object as the threatening object, wherein the generating of the at least one notification is further based on the determining of the threat level, wherein the at least one notification comprises the threat level.

17. The system of claim 16, wherein the processing device is further configured for:
obtaining a plurality of area data of a plurality of areas comprised in the region;
analyzing the plurality of area data; and
determining a sensitiveness associated with each of the plurality of areas, within each of the plurality of areas and the at least one object based on the analyzing of the plurality of area data and the analyzing of the at least one object characteristic, wherein the determining of the threat level is further based on the sensitiveness.

18. The system of claim 10, wherein the processing device is further configured for streaming the at least one monitoring data to the at least one device based on based on the classifying of the at least one object as the threatening object.
